(19) United States
(12) Patent Application Publication
(10) Pub. No.: US 2007/0253588 A1
(43) Pub. Date: Nov. 1, 2007

(54) Eyewear device with signal communicative members

(76) Inventor: Richard Kazuhiro Sanpei, Paso Robles, CA (US)

Correspondence Address: BAKER, DONELSON, BEARMAN, CALDWELL & BERKOWITZ, SIX CONCOURSE PARKWAY, SUITE 3100, ATLANTA, GA, 30328, US

(21) Appl. No.: 11/288,917

(22) Filed: Nov. 29, 2005

(51) Int. Cl. H04R 25/00

(52) U.S. Cl. 381/381; 381/380

(57) ABSTRACT

An eyewear device in which a front guard member includes a lens portion and a bridge portion to support the lens portion from the nose of the human being, with a pair of temples hingedly connected to opposing ends of the front guard member and having a right and a left hearing assembly, each assembly including an arm member that slides into the tubular shaped end of the temple and a leg member pivotally attached to the arm member and the leg member including an audio earplug attachment means whereby an audio earplug is attached to the leg member for communicating an audio signal from a sound source. In an alternate embodiment, the audio earplugs attach to a signal carrier held within a band that attaches at opposing ends to the temples. A sound source selectively connects to the audio earplugs.

### TECHNICAL FIELD

The present invention relates to eyewear devices. More particularly, the present invention relates to eyewear devices with signal communicative members useful with eyewear and with portable audio devices.

### BACKGROUND OF THE INVENTION

Eyewear devices have long been provided for a number of different purposes including the correcting of the vision of persons, the shielding eyes from glare, and the protecting of eyes from injury from flying debris such as from manufacturing, machine work, forestry, construction, and other work activities. Eyewear devices typically have a front panel defined by a frame and a pair of lenses mounted in the frame in alignment with the eyes of the person wearing the eyewear device. The frame includes a bridge that rests directly or on extended pads on the upper ridge of the nose. Temples extend from sides of the frame rearwardly along opposing sides of the face and terminate in rounded end portions that seat arcuately over and behind the ears. Often the eyewear is connected to a neck cord for supporting the eyewear when not in use by the person, typically reading glasses or sunglasses but other eyewear that is not required continuously for use.

In addition to protecting eyes, devices have been provided for aural protection of a person. Generally, these types of devices insert into the ear and close or reduce communication of sound waves to the inner ear. These devices are typically compressed from a nominal size to a reduced size for being received within the ear. Upon release, the device seeks to resume its normal size by expansion. The sides of the device press again the ear surfaces and close the ear to significant communication of sound waves.

While protection of eyes and vision and of ears and hearing is important, recent developments in technology provides a number of portable audio devices including radios for receiving broadcasts and recording and playback devices that have storage capacity for many hundreds of minutes of audio signals. The recording and playback devices enable a person to have with him selected music, oral recitations of published books, or similar oral audio content. The audio devices typically can be attached with holders to the clothing of the person using the devices.

The devices include plug-in speakers or headsets whereby the person using the device may set an audio volume level for comfortable listening but the audio level is insufficient for nearby persons to hear. The speakers typically have housing known in the trade as “ear buds” configured for disposing within an ear while headsets position speakers outwardly of the ear. The speakers and headsets connect through signal carrying wires that connect with a plug to a signal output receptacle on the audio device. The wires overlie the clothing and extend from the device to the headset or ear buds. The wires however may interfere with the use of the eyewear.

Accordingly there is a need in the art for providing selectively connectable signal communicative neck cords for use with eyewear and audio devices. It is to such that the present invention is directed.

### SUMMARY OF THE INVENTION

The present invention meets the need in the art by providing an eyewear device for use by a human being, comprising a front guard member including a lens portion for protecting the eyesight of the human being and having opposing ends with a bridge portion located medial the opposing ends of the front guard member to support the lens portion from the nose of the human being. A pair of temples hingably attaches at a first end to a hinge connection means at respective opposing ends of the front guard member. At least one hearing assembly includes an arm member configured to attach to the end of the temple and a leg member pivotally attached to the arm member allowing for rotational movement of the arm member and leg member around the pivoting attachment. The leg member includes an audio earplug attachment means whereby an audio earplug is attached to the leg member for communicating an audio signal from a sound source.

In another aspect, the present invention provides a neck cord for eyewear, comprising an elongate band including a signal carrier and an attaching means for attaching the band at opposing distal ends to respective temples of an eyewear device. A connector attaches to the signal carrier for communicating a signal from a signal source selectively coupled to the connector to a pair of speakers adapted for being disposed near respective ears of a person wearing the eyewear device and when connected to the signal carrier for communicating sound therefrom. The speakers disposed near the ears thereby communicating sound from the signal source while the band enables suspending the eyewear when not used for eyewear purposes.

Objects, advantages and features of the present invention will become apparent from reading of the following detailed description of the invention and claims in view of the appended drawings.

### BRIEF DESCRIPTION OF THE DRAWINGS

FIG. 1 illustrates in top plan view an eyewear device and sound earpods for connecting to a sound source, according to the present invention.

FIG. 2 illustrates in perspective view a neck cord for supporting eyewear not in eyewear use while providing audio signals through earpod speakers, in accordance with the present invention.

FIG. 3 illustrates in detailed exploded view an alternate embodiment of the eyewear and neck cord apparatus illustrated in FIG. 2.

FIG. 4 illustrates in side view an eyewear device illustrated in FIG. 1 with an alternate embodiment sound earpod that incorporates a microphone, for connecting to a bi-directional communication device.

### DETAILED DESCRIPTION

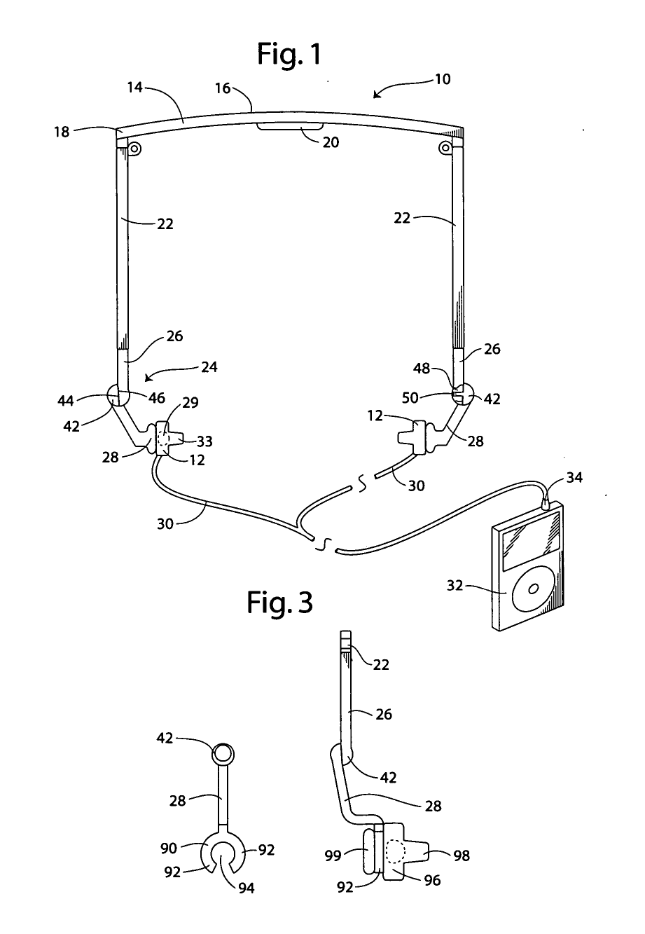

Referring now in more detail to the drawings in which like numerals refer to like parts throughout the several views, FIG. 1 illustrates in top plan view an eyewear device 10 with a sound communicating earpod 12 according to the present invention useful for communicating sound through sound communicators or speakers within the earpod in conjunction with ordinary use of the eyewear device 10.

My U.S. Pat. No. 6,382,213 describes an eyewear device for the protection of sight and hearing that readily configures for the present invention. The eyewear 10 includes a front guard portion 14 having a transparent panel section 16 connected to an elongated resilient member 18. A bridge member 20 extends from the member 18 for seating on a ridge of a nose of the wearer of the eyewear. Temples 22 hingedly attach to respective ends of the member 18 and pivot between an overlapping closed position against the panel section 16 and a perpendicular extended position for looping the ends of the temples 22 over the ears.

A hearing assembly generally 24 attaches to at least one of the temples 22. Each hearing assembly 24 includes an arm 26 configured to telescopically connect with the end of the temple 22, such as mating tubular members, and a leg 28 pivotally attached to the arm 26 allowing for rotational movement of the arm and leg around the pivoting attachment. It is to be appreciated that the arm 26 may connect to the distal end of the temple 22 in other conventional ways, such as integrally or fixedly attached. An audio earpod 12 includes a speaker 29 for communication of sound and attaches to a distal end of the leg 28. The speaker in the earpod 12 connects by wires 30 to a sound source 32. The sound source 32 is any number of types of sound, such as a personal music recording and playback device, cellular telephone, or receiver player device configured for receiving remote radio broadcast signals from antennas or satellite.

The earpod 12 includes a housing that holds the speaker 29 and a distal portion is formed of a cushion or resilient material such as foam or soft plyable plastic configured for being received within an ear of the person using the eyewear 10. The wires 30 attach to the speaker in the earpod 12 and terminate at a connector 34 for connection to the source 32 of sound.

The arm 26 and leg 28 are connected by a pivot 42 so as to allow rotational movement around the pivot. The arm 26 and leg 28 each have opposing planar surfaces 44, 46 that contact and connect with a pivot post 48 extending from the planar surface 44 as shown in cut-away view on the right side in FIG. 1 through a pivot hole 50. The surfaces 44, 46 in the illustrated embodiment are knurled or roughened with projections so as to provide resistance to movement of the arm and leg in their relationship to each other. In an alternate embodiment, a washer is disposed between the planar surfaces 44, 46 to guide the relative movement of the arm and leg.

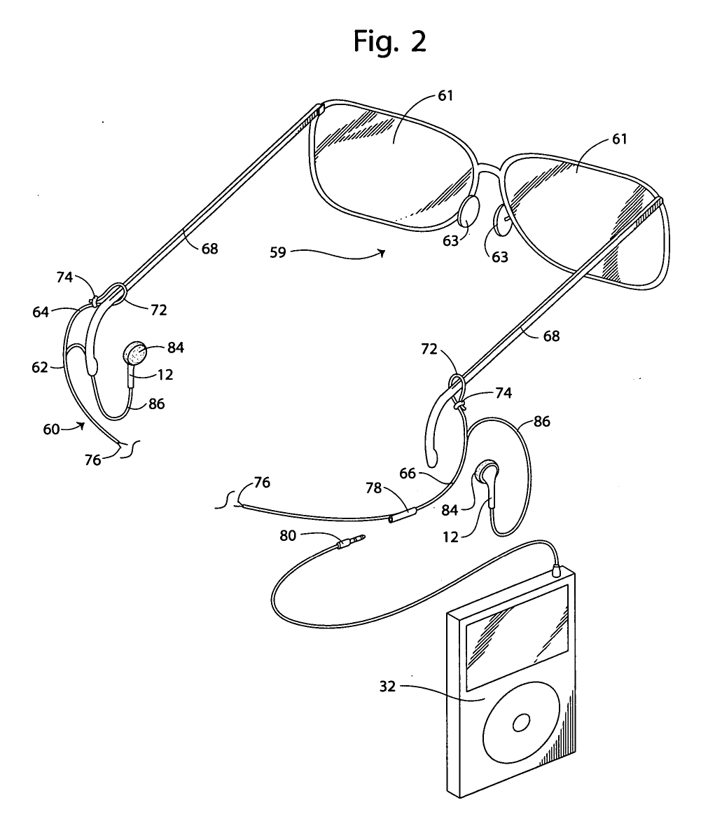

FIG. 2 illustrates in perspective view a conventional eyewear device 59 having lens 61 and bridge feet 63, with a neck cord 60 for supporting the eyewear while not in eyewear use and providing audio signals through earpod speakers 12, in accordance with the present invention. The neck cord 60 comprises an elongated band 62 having opposing distal ends 64, 66 configured for attaching to temples 68 of the eyewear device 59. In the illustrated embodiment, the distal ends 64, 66 of the neck cord 60 each include a looped portion 72 formed by a clip 74 that holds looped distal portions of the band 60. The elongated band 60 includes a signal carrier or wires 76 for carrying a stereo audio signal to the opposing pair of earpods 12. The wires 76 attach to a connector or jack 78 attached to the band 60. The connector 78 selectively detachably engages a mating connector 80 that operatively communicates with the signal source 32. As discussed above, the signal source 32 is a source of sound, such as a personal music recording and playback device, cellular telephone, or receiver player device configured for receiving remote radio broadcast signals from antennas or satellite. The band 60 is a fabric material such as cotton, polyester, or other fabric, and includes within the fabric the wires 76 extending longitudinally within the band.

The signal carrier 76 connects to a pair of sound communicators or speakers in the earpods 12. The earpods 12 in the illustrated embodiment each include a bulbular housing 84 that encloses a speaker. The housing 84 is configured for being received and held within an ear of the person using the eyewear device 10. The sound communicators attach at respective ends with a free length generally 86 at an end portion of the neck cord 60, to facilitate positioning the sound communicators within the respective ears spaced from the temples 68 of the eyewear device 59. It may be appreciated that the neck cord 60 is readily used with the eyewear device 10 illustrated in FIG. 1.

In an alternate embodiment illustrated in FIG. 3, the leg 28 of the audio assembly 24 terminates at a distal end with arcuate opposing members 92 that cooperatively define a C-shaped receiving port 94. The receiving port 94 detachably receives an audio earpod 96 containing as does the earpod 12 a speaker and a cushioned end 98 for being received within an ear. The audio earpod 96 also is configured at one end 99 for mating engagement with the receiving port 94. The earpod 96 selectively detaches from the receiving port 94 and the speaker therein is removed, for replacement of the cushioned portion of the earpod, to enable replacement after extensive use.

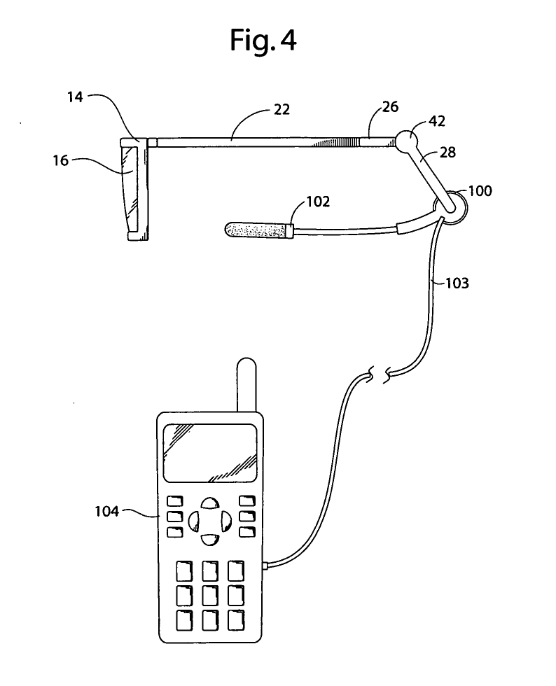

FIG. 4 illustrates in side view the eyewear device 10 illustrated in FIG. 1 with an alternate embodiment sound earpod 100 in the hearing assembly 24 attached to one of the temples 22. The earpod 100 incorporates the speaker 29 together with a microphone 102 and cord 104, for connecting to a bi-directional communication device 104 such as a cellular telephone. The other temple 22 may include the hearing assembly 24 having the earpod 12, as discussed above.

With reference to FIG. 1, the arms 26 extend selectively from the temples 22 and the legs 28 pivot relative to the arms 26, to position the earpods 12 aligned with the ears for being fitted within the ears. The sound source 32 connects with the connector 34 to the wires 30 for communicating audio signals through the wires to the speakers in the earpods 12. In one embodiment, the speaker is enclosed by a large foam pad, so that the speaker is positioned outwardly of but aligned with the ears for communicating sound.

With reference to FIG. 2, the neck cord 60 attaches with the looped distal portions 72 sliding over the distal ends of the temples 68. The neck cord 60 allows suspending the eyewear 59 (or 10) about the neck of the person using the eyewear, for example, sunglasses and the person removes the sunglassess when inside a building or in shade, with the eyewear suspended about the neck. However, the neck cord 60 facilitates use of the person's audio device or signal source 32 by connecting the connectors 28 and 30. The signal from the signal source 32 communicates through the wires 76 to the speakers in the earpods. The housings 84 are received in the ears of the wearer for communicating the sound to the person.

With reference to FIG. 3, the earpod selectively detachably engages the hook 90 of arm 28. After use or wear of the housing, the earpod can detach from the hook, and the cushioned pad removed and replaced. After replacement with a new cushion receiving the speaker, the earpod re-attaches to the hook 90.

The eyewear 10 illustrated in FIG. 4 is particularly configured with an alternate embodiment hearing assembly 24 for bi-directional communication using a cellular telephone 104 or similar device for listening to audio through the sound earpod 100 and communicating voice or sound though the microphone 102. The opposing temple may include the earpod 12, or lack the earpod, so only one ear of the person using the eyewear device is provided with sound from the sound source.

This specification has described the present invention that provides a hard cover product with a concealed security device, including the steps necessary for making and using various embodiments thereof. It is to be understood, however, that numerous changes and variations may be made in the construction of the present hard cover product within the spirit and scope of the present invention, and that modifications and changes may be made therein without departing from the scope thereof as set forth in the appended claims.

What is claimed is:

1. An eyewear device for use by a human being, comprising:
a front guard member including a lens portion for protecting the eyesight of the human being and having opposing ends;
a bridge portion located medial the opposing ends of the front guard member to support the lens portion from the nose of the human being;
a hinge connection means attached to each of the opposing ends of the front guard member,
a pair of temples hingably attached at one end to a respective one of the hinge connection means,
at least one hearing assembly that includes an arm attached to a distal end of the temple and a leg pivotally attached to the arm allowing for rotational movement of the arm and leg around the pivoting attachment, the leg includes an audio earplug attachment means whereby an audio earplug is attached to the leg for communicating an audio signal from a sound source.

2. The eyewear device as recited in claim 1, further comprising:
an elongate band including a signal carrier;
means for attaching the band at opposing distal ends to respective temples of an eyewear device;
a connector attached to the signal carrier for communicating a signal from a signal source selectively coupled to the connector;
the audio earplugs attached to the signal carrier at a respective distal end portion of the band for being disposed near respective ears of a person wearing the eyewear device and when connected to the signal source communicating sound therefrom,
whereby the speakers disposed near the ears for communicating sound from the signal source while the band enables suspending the eyewear when not used for eyewear purposes.

3. The eyewear device as recited in claim 1 wherein the earplug attachment means is an earplug post projecting from an earplug attachment end of the leg.

4. The eyewear device as recited in claim 1, wherein the earplug attachment means comprises a C-shaped distal end that defines an at least partially encircled void into which the earplugs are inserted and held securely.

5. The eyewear device as recited in claim 1, wherein a planar surface of the arm and a planar surface of the leg contact each other providing frictional resistance to movement.

6. The eyewear device as recited in claim 5, wherein planar surfaces of the arm and the leg contain obstructions thereby providing increased resistance to movement.

7. The eyewear device as recited in claim 5, further comprising a washer sandwiched between the planar surfaces of the arm and the leg to provide frictional resistance to movement.

8. The eyewear device as recited in claim 1, further comprising a microphone attached to the leg for communicating with a sound communicator device.

9. The eyewear device as recited in claim 1, wherein the distal end of the temple and the arm are tubular and configured to slidably telescope relative to each other for selectively positioning the arm relative to an ear of the person using the eyewear device.

10. A neck cord for eyewear, comprising:
an elongate band including a signal carrier;
means for attaching the band at opposing distal ends to respective temples of an eyewear device;
a connector attached to the signal carrier for communicating a signal from a signal source selectively coupled to the connector;
at least one speaker adapted for being disposed near an ear of a person wearing the eyewear device and when connected to the signal carrier for communicating sound therefrom,
whereby the speaker disposed near the ear for communicating sound from the signal source while the band enables suspending the eyewear when not used for eyewear purposes.

11. The neck cord as recited in claim 10, wherein the speakers each comprise a bulbular housing adapted for being received within an ear.

12. The neck cord as recited in claim 10, wherein the signal device comprises a cellular telephone.

13. The neck cord as recited in claim 12, further comprising a microphone attached to the leg for communicating with the cellular telephone.

14. The neck cord as recited in claim 10, wherein the signal source comprises a recorder player device having memory for storing signals of audio material and for communicating the signals selectively to the speaker.

15. The neck cord as recited in claim 10, wherein the signal source comprises a receiver player that receives broadcast signal is from a remote signal communication device and communicates the received signals to the speaker.

16. An eyewear and audio device for a person, comprising:
a front guard that includes a transparent panel section for disposing forwardly of a pair of eyes for a person, a bridge portion that seats on an upper edge of a nose of the person to support the panel section, and opposing distal ends;
a pair of temples each attached at one end to a respective distal end of the front guard and at least one temple including an earplug sound assembly connected to the opposing distal end;
the earplug sound assembly comprising a support member that pivotally extends from the temple at an oblique angle and terminates in a housing that encloses a sound communicator, the support member selectively oriented relative to the temple for disposing the housing near an ear of a person using the eyewear device;
means for connecting the earplug sound assembly to a signal source for communicating a signal to the sound communicator for communicating sound therefrom,
whereby the sound communicator disposed near the ear for communicating sound from the signal source while the eyewear is being used for eyewear purposes.

17. The eyewear and audio device as recited in claim 16, further comprising:
an elongate band that includes a signal carrier;
means for attaching the band at opposing distal ends to a respective temple; and
a connector attached to the signal carrier for communicating a signal from the signal source selectively coupled to the connector,
whereby the elongate band supports the eyewear device about the neck of the person while being worn but not for eyewear uses.

18. The eyewear and audio device as recited in claim 17, wherein the sound communicator comprises a speaker for communicating sound based on electrical signals communicated thereto through the signal carrier.

19. The eyewear and audio device as recited in claim 17, wherein the housing is adapted for being received within an ear.

20. The eyewear and audio device as recited in claim 16, wherein the signal source comprises a cellular telephone.

21. The eyewear device as recited in claim 16, further comprising a microphone attached to the leg for communicating with a sound communicator device.

22. The eyewear and audio device as recited in claim 16, wherein the signal source comprises a recorder player device having memory for storing signals of audio material and for communicating the signals selectively to the sound communicators.

23. The eyewear and audio device as recited in claim 22, wherein the signal source comprises a receiver player that receives broadcast signals from a remote signal communication device and communicates the received signals to the sound communicators.

24. The eyewear device as recited in claim 16, wherein the distal end of the temple is tubular and configured to slidably telescopically receive the support member for selectively positioning the sound communicator relative to an ear of the person using the eyewear device.
